(19) United States
(12) Patent Application Publication
(10) Pub. No.: US 2021/0204561 A1
(43) Pub. Date: Jul. 8, 2021

(54) FAST SETTING EDIBLE GLUE

(71) Applicant: eRaey AB, Norrkoping (SE)

(72) Inventor: Emelie Rengart, Norrkoping (SE)

(21) Appl. No.: 15/999,652

(22) PCT Filed: Feb. 16, 2017
(86) PCT No.: PCT/SE2017/050148

§ 371 Date: Aug. 20, 2018

(30) Foreign Application Priority Data
Feb. 19, 2016 (SE) 1650216-3

(51) Int. Cl. A23G 3/42; A23G 3/34; A23L 29/25

(52) U.S. Cl. CPC A23G 3/42; A23V 2002/00; A23L 29/25; A23G 3/343

(57) ABSTRACT

A fast setting edible glue comprising a gum, powdered sugar, glucose, water, and optionally additional additives, the edible glue comprises: gum in an amount of from 2 to 4% based on the total amount of glue; powdered sugar in an amount from 82-88% based on the total amount of glue; glucose in an amount of from 1 to 3% based on the total amount of glue; water in an amount of from 8 to 12% based on the total amount of glue; and optionally additional additives in an amount of from 0.1 to 1.5% based on the total amount of glue.

### TECHNICAL FIELD

This disclosure relates to edible glue or adhesive which is fast hardening and which can be used for piecing together both smaller and larger items of baked goods.

### BACKGROUND

When making baked goods such as cakes, cup cakes and other decorated confectionery items, there is often a need to able to piece together different items. Edible glue, i.e. a glue or fixative which comprises edible ingredients must therefore be used. The glue should of course also be palatable and not deteriorate the look of the confectionary or baked goods.

When piecing together larger items of baked goods, for instance when making gingerbread houses and other larger constructions, the glue must also be able to fasten the pieces and not break under the strain of the weight of the pieces. A further requirement is that the glue also hardens or dries quickly in order to hold the pieces together.

There are a number of ways to achieve edible glues or fixatives today. When making gingerbread houses a conventional way is to melt sugar and use the caramelized sugar to piece the house together. However, the caramelized melted sugar is extremely hot and not very convenient to use. Further to this the brownish color of the caramelized sugar may discolor the decorations subsequently put on the house, such as icing or frosting etc. Another way to piece together a gingerbread house is simply to use a conventional frosting or icing, which is usually made from water and icing or powdered sugar and lemon juice. However, not only is the icing slow hardening, it is also quite weak and may not be able to hold lager constructions together.

There are also other edible glues available commercially, which does not require heating, such as Wilton Dab′n′Hold edible glue, but this glue is only suitable for gluing smaller pieces together such as smaller decorative items on a cake or a cup cake. There are also a number of different recipes available for variants of the commercially available edible glue, but none of these glues are suitable for larger pieces and are not fast hardening. One such glue recipe is disclosed on http://sweetopia.net/2009/09/how-to-make-edible-glue/.

There is thus a need for edible glue, which does not require that the user heats it up prior to use and which hardens quickly once it has been applied to the item to be glued.

### SUMMARY

It is an object of the present invention to provide improved edible glue. It is a particular object to provide glue which can be used when it's cool, or even room tempered, and which hardens or sets quickly after being applied.

The object is wholly or partially achieved by a glue and a method according to the appended independent claims. Embodiments are set forth in the appended dependent claims, and in the following description.

According to a first aspect there is provided a fast setting edible glue comprising a gum, powdered sugar, glucose, water, and optionally additional additives, wherein the edible glue comprises gum in an amount of from 2 to 4% based on the total amount of glue; powdered sugar in an amount from 70-80% based on the total amount of glue; glucose in an amount of from 2 to 5% based on the total amount of glue; water in an amount of from 12 to 18% based on the total amount of glue; and optionally additional additives in an amount of from 0.1 to 1.5% based on the total amount of glue.

This edible glue has surprisingly shown to have an excellent setting ability and hardens quickly, i.e. within 60 minutes from being applied, preferably at least a portion of the glue is set within 20 minutes. The glue is further semisolid in room temperature, which means that it can be easily handled, and it can be easily applied to the items to be glued. Further it is very palatable, and does not impair the look of the confectionary goods.

The glucose may be in any one of a liquid form or dry form. This means that the glucose used may either be a liquid or semi-liquid form of glucose or glucose syrup or a dried glucose such as a spray dried glucose or glucose syrup. When using a liquid form the glue can preferably be ready made for use and packaged, and when using the dried form of glucose a type of semi-manufactured glue can be provided, where the user themselves can mix the dry ingredients with water to form the glue. This can preferably be done just before the glue is to be used.

The gum may beany one of gum karaya, gum tragacanth, gum arabic, and carboxymethyl cellulose (CMC) gum, or derivatives or mixtures thereof.

The additional additive may be any one of a color agent, a preservative agent, thickening agent and a flavor agent.

The additional additive is preferably a food grade additive. Adding a preservative may be beneficial for the shelf life of the glue. A color agent may be added if it is desirable to have a particular color of the glue. The additional additive may further be in a dry or liquid form, depending on the desired form of the glue mixture.

The preservative agent may be any one of citric acid, and potassium sorbate.

The glue may comprise, gum in an amount of 3% based on the total amount of glue, wherein the gum is gum karaya, powdered sugar in an amount of 76% based on the total amount of glue; glucose in an amount of around 4.8% based on the total amount of glue; and water in an amount of 15.5% based on the total amount of glue and wherein said glucose is in a liquid form.

Alternatively the glue may comprise, gum in an amount of 3% based on the total amount of glue, wherein the gum is gum karaya, powdered sugar in an amount of 76% based on the total amount of glue; glucose in an amount of around 3.8% based on the total amount of glue; and water in an amount of 16.5% based on the total amount of glue and wherein said glucose is in a dry form.

According to a second aspect there is provided a method of producing a fast setting edible glue comprising the steps of providing a gum in an amount of from 2 to 4% based on the total amount of glue; providing powdered sugar in an amount from 70-80% based on the total amount of glue; optionally providing additional additives in an amount of from 0.1 to 1.5% based on the total amount of glue; mixing said gum and said powdered sugar, to form a dry ingredient mixture; and optionally said additional additive(s); providing glucose in a liquid form in an amount of from 2 to 5% based on the total amount of glue; water in an amount of from 12 to 18 based on the total amount of glue; mixing said glucose and water; heating said mixture of glucose and water, until the glucose is fully dissolved; and mixing said dry ingredients mixture with said mixture of glucose and water; thereby forming said edible glue.

As an alternative to the method of the second aspect, there is provided a method of producing a fast setting edible glue comprising the steps of providing a gum in an amount of from 2 to 4% based on the total amount of glue; providing powdered sugar in an amount from 70-80% based on the total amount of glue; providing glucose in a dry form in an amount of from 2 to 5% based on the total amount of glue; optionally providing additional additives in an amount of from 0.1 to 1.5% based on the total amount of glue; mixing said gum, said powdered sugar, and said glucose in dry form to form a dry ingredient mixture; and providing water in an amount of from 12 to 18% based on the total amount of glue; and mixing said dry ingredient mixture with the water, thereby forming said edible glue.

This provides for an edible glue which can be kept in a dry form and then mixed with water just prior to use. This could for instance reduce the cost of transportation and storage, and may allow for a longer shelf life of the glue. The water may alternatively be heated before mixing it with the other ingredients in order to facilitate the mixing and dissolving of the dry ingredients, but the water may also be cold or room tempered.

The wherein the steps of heating and mixing may preferably be performed under stirring, since by stirring the mixture when heating it the ingredients may be more easily dissolved, however this step is not essential.

Both methods may further comprise the step of allowing said mixture to cool.

Both methods may further comprises the step of placing said edible glue in a substantially airtight container before it has started to harden.

The mixture may be hot, warm or cooled when placed in the container. This means that the mixture is still semisolid when it is placed in the container. By substantially airtight is meant that the container is sealed after the glue mixture has been placed therein to prevent the glue from setting during storage. When the dry mixture is prepared this may be placed in an air-tight container before the dry mixture is dissolved in water to form the edible glue.

According to a third aspect there is provided a fast setting edible glue comprising gum, powdered sugar, glucose, water and optionally additional additives manufactured according to any one of the methods according to the second aspect.

According to a fourth aspect there is provided the use of a fast setting edible glue according to the first and third aspects for gluing foods, baked goods and confectionary items.

### DETAILED DESCRIPTION

The glue or adhesive comprises a gum, powdered sugar, glucose, water, and optionally additional additives. The edible glue or adhesive comprises gum in an amount of from 2 to 4% based on the total amount of glue, powdered sugar in an amount from 70 to 80% based on the total amount of glue, glucose, or dextrose, in an amount of from 2 to 5% based on the total amount of glue, water in an amount of from 12 to 18% based on the total amount of glue; and optionally additional additives in an amount of from 0.1 to 1.5% based on the total amount of glue.

The glucose or glucose syrup may be in a liquid or semi-liquid form or a dry form.

The fast hardening or fast setting glue is manufactured by mixing together the dry ingredients of the glue (the gum, sugar). The wet ingredients the wet ingredients (liquid glucose and water) are mixed under heating. The dry ingredients may then be mixed with the wet ingredients, such that all the ingredients dissolve to form an edible glue mixture. The mixture may then allowed to cool for a while before it is placed in a container, or it is placed in the container while the mixture is still hot or warm, and sealed such that the glue is prevented from staring to set and become hard. The mixture may thus only be allowed to cool to the point where it is still semisolid.

Alternatively the fast hardening or fast setting glue is manufactured by mixing together the dry ingredients of the glue (the gum, sugar and the dry glucose). The dry ingredient may be placed in a container for storage and transportation before being mixed with the water. The dry ingredients may then be mixed with the water, which may be warm or hot such that all the dry ingredients easily dissolve to form the edible glue mixture, but it may also be cold or room tempered.

The optional additional additives may be mixed either with the dry or wet ingredients or with the edible glue mixture.

The container may be any suitable type of container such as a bag, bottle or container made from any type of suitable material such a plastic, aluminum, glass, paper, paperboard or combinations thereof.

The gum is preferably a food grade gum, of which there are many different types.

The food grade gum may for instance be any one of number of different types of gums, or thickening agents, including any one of gum karaya (E416), gum tragacanth (E413), gum Arabic (E414), and carboxymethyl cellulose (CMC, E466) gum, or derivatives or mixtures thereof, but it is also conceivable to use other types of suitable gums for this purpose.

The gum may also be a readymade gum mixture such as the commercial product Gum Tex® sold by Wilton.

The additional additives may be agents for color, aroma, flavor, additional thickening or preservation. The glue may also comprise a mixture of different additional additives. The additional additives are preferably of food grade. The additional additives may be in a dry or liquid form depending on the desired use.

The preservative agent may be any type of conventionally used preservative, such as citric acid (E330) or potassium sorbate (E202).

The color agent may be any type of conventional color agent available.

The glue may be used for any type of application where food items are to be glued together.

### Example 1

A batch of glue was manufactured by mixing the dry ingredients 7.65 g of gum karaya with 183.7 g of powder sugar. 11.7 g of liquid glucose was mixed with 37.5 g of hot water and mixed until the liquid glucose was completely dissolved. The mixture of dry ingredients where then mixed with the liquid glucose and water, preferably under stirring, to form a semisolid substance.

The heated mixture or semisolid substance was then placed in a sealed container.

The glue was then used to glue gingerbread house parts together. The glue allowed for the parts to be instantly fixated to each other, i.e. it was sticky, yet flowable enough, already when applied and had fully hardened within 60 minutes. Further, a smaller portion of the glue was fully hardened within 20 minutes.

### Example 2

A batch of glue was manufactured by mixing the dry ingredients 7.65 g of gum karaya with 183.7 g of powder sugar and 9 g of dry glucose (spraydried glucose). The dry mixture was mixed with 39.6 g of warm or hot water and mixed until the dry ingredients had completely dissolved to form a semisolid substance, i.e. the edible glue. The glue was then used to glue gingerbread house parts together. The glue allowed for the parts to be instantly fixated to each other, i.e. it was sticky, yet flowable enough, already when applied and had fully hardened within 60 minutes. Further, a smaller portion of the glue was fully hardened within 20 minutes.

In Table 1 the ingredients of Examples 1 and 2 are shown as percentages of the total mixture.

TABLE 1
Ingredients according to Examples 1 and 2

| | |
|---|---|
| Liquid glucose | Dry glycose |

| Ingredient | Weight (g) | % | Weight | % |
|---|---|---|---|---|
| Water | 37.5 | 15.59 | 39.6 | 16.50 |
| Powdered sugar | 183.7 | 76.37 | 183.7 | 76.56 |
| Glucose liquid | 11.7 | 4.86 | — | — |
| Glucose dry | — | — | 9 | 3.75 |
| Gum karaya | 7.65 g | 3.18 | 7.65 | 3.19 |

1. A fast setting edible glue comprising a gum, powdered sugar, glucose, water, and additional additives,
the edible glue comprises:
gum in an amount of from 2 to 4% based on the total amount of glue;
powdered sugar in an amount from 70-80% based on the total amount of glue;
glucose in an amount of from 2 to 5% based on the total amount of glue;
water in an amount of from 12 to 18% based on the total amount of glue; and
additional additives in an amount of from 0.1 to 1.5% based on the total amount of glue.

2. The fast setting edible glue as claimed in claim 1, wherein said glucose is in any one of a liquid form or dry form.

3. The fast setting edible glue as claimed in claim 1, wherein the gum is any one of gum karaya, gum tragacanth, gum arabic, and carboxymethyl cellulose (CMC) gum, or derivatives or mixtures thereof.

4. The fast setting edible glue as claimed in claim 1, wherein the additional additive is any one of a color agent, a preservative agent, thickening agent and a flavor agent.

5. The fast setting edible glue as claimed in claim 4, wherein the preservative agent is any one of citric acid, and potassium sorbate.

6. The fast setting edible glue as claimed in claim 1, wherein the glue comprises, gum in an amount of 3% based on the total amount of glue, wherein the gum is gum karaya, powdered sugar in an amount of 76% based on the total amount of glue; glucose in an amount of around 4.8% based on the total amount of glue; and water in an amount of 15.5% based on the total amount of glue and wherein said glucose is in a liquid form.

7. The fast setting edible glue as claimed in claim 1, wherein the glue comprises, gum in an amount of 3% based on the total amount of glue, wherein the gum is gum karaya, powdered sugar in an amount of 76% based on the total amount of glue; glucose in an amount of around 3.8% based on the total amount of glue; and water in an amount of 16.5% based on the total amount of glue and wherein said glucose is in a dry form.

8. A method of producing a fast setting edible glue comprising the steps of:
providing a gum in an amount of from 2 to 4% based on the total amount of glue;
providing powdered sugar in an amount from 70-80% based on the total amount of glue;
providing additional additives in an amount of from 0.1 to 1.5% based on the total amount of glue;
mixing said gum and said powdered sugar, to form a dry ingredient mixture; and said additional additive(s);
providing glucose in a liquid form in an amount of from 2 to 5% based on the total amount of glue;
water in an amount of from 12 to 18% based on the total amount of glue;
mixing said glucose and water;
heating said mixture of glucose and water, until the glucose is fully dissolved; and mixing said dry ingredients mixture with said mixture of glucose and water; thereby forming said edible glue.

9. A method of producing a fast setting edible glue comprising the steps of
providing a gum in an amount of from 2 to 4% based on the total amount of glue;
providing powdered sugar in an amount from 70-80% based on the total amount of glue;
providing glucose in a dry form in an amount of from 2 to 5% based on the total amount of glue;
providing additional additives in an amount of from 0.1 to 1.5% based on the total amount of glue;
mixing said gum, said powdered sugar, and said glucose in dry form to form a dry ingredient mixture; and
providing water in an amount of from 12 to 18% based on the total amount of glue; and
mixing said dry ingredient mixture with the water, thereby forming said edible glue.

10. The method as claimed in claim 8, wherein the steps of heating and mixing are preferably performed under stirring.
since by stirring the mixture when heating it the ingredients may be more easily dissolved, however this step is not essential.

11. The method as claimed in claim 8, wherein the method further comprises the step of allowing said mixture to cool.

12. The method as claimed in claim 8, wherein the method further comprises the step of placing said edible glue in a substantially airtight container before it has started to harden.

13. A fast setting edible glue comprising gum, powdered sugar, glucose, and water, wherein the edible glue is made by the steps of:
providing a gum in an amount of from 2 to 4% based on the total amount of glue;
providing powdered sugar in an amount from 70-80% based on the total amount of glue;
providing additional additives in an amount of from 0.1 to 1.5% based on the total amount of glue;
mixing said gum and said powdered sugar, to form a dry ingredient mixture; and said additional additive(s);
providing glucose in a liquid form in an amount of from 2 to 5% based on the total amount of glue;
water in an amount of from 12 to 18% based on the total amount of glue;
mixing said glucose and water;
heating said mixture of glucose and water, until the glucose is fully dissolved; and
mixing said dry ingredients mixture with said mixture of glucose and water; thereby forming said edible glue.

14. A method of using a fast setting edible glue, the method comprising:
providing the edible glue comprising:
gum in an amount of from 2 to 4% based on the total amount of glue;
powdered sugar in an amount from 70-80% based on the total amount of glue;
glucose in an amount of from 2 to 5% based on the total amount of glue;
water in an amount of from 12 to 18% based on the total amount of glue; and
additional additives in an amount of from 0.1 to 1.5% based on the total amount of glue; and
using the edible glue for gluing foods, baked goods and confectionary items.

15. The method as claim in claim 10, wherein the method further comprises the step of allowing said mixture to cool.

16. The method as claim in claim 9, wherein the method further comprises the step of placing said edible glue in a substantially airtight container before it has started to harden.

17. Use of a fast setting edible glue as claimed in claim 6 for gluing foods, baked goods and confectionary items.

18. Use of a fast setting edible glue as claimed in claim 7 for gluing foods, baked goods and confectionary items.
